(19) United States
(12) Patent Application Publication
(10) Pub. No.: US 2018/0011934 A1
(43) Pub. Date: Jan. 11, 2018

(54) IDENTIFYING SPATIAL RECORDS

(71) Applicant: CoStar Realty Information, Inc., Washington, DC (US)

(72) Inventor: Kevin Lee Stapleton, Encinitas, CA (US)

(21) Appl. No.: 15/644,094

(22) Filed: Jul. 7, 2017

Related U.S. Application Data
(60) Provisional application No. 62/359,412, filed on Jul. 7, 2016.

(51) Int. Cl. G06F 17/30; G06Q 50/16

(52) U.S. Cl. CPC G06F 17/30864; G06Q 50/16

(57) ABSTRACT

Methods, including computer programs encoded on a computer storage medium, for determining whether a spatial record is located within a polygon. In one aspect, a method includes: receiving data identifying a polygon positions on a coordinate system, identifying a plurality of lines to represent the polygon, accessing information that identifies a spatial record position at a location on the coordinate system using a spatial index that includes spatial data and non-spatial data, generating a ray that emanates from the spatial record and that is projected in a particular direction, determining whether the spatial record is located within the polygon based on a number of times that the ray intersects the plurality of lines, and outputting information that identifies whether the spatial record is located within the polygon.

### CROSS-REFERENCE TO RELATED APPLICATIONS

This application claims the benefit of U.S. Provisional Patent Application No. 62/359,412 filed Jul. 7, 2016 and entitled “Identifying Spatial Records,” which is incorporated herein by reference in its entirety.

### FIELD

The present specification relates to search engines.

### BACKGROUND

In recent years, online search services have changed the way that people obtain information on assets and services of their interest. Users are now able to navigate up-to-date listings for assets and services using a variety of different communication devices (e.g., smart phones, personal computers, personal digital assistants (PDAs), etc.), and are doing so with increasing regularity.

### SUMMARY

Although users of online real estate search services may have vast amounts of real estate information at their fingertips, they are often faced with the burdensome task of sifting through listings that include incomplete information. The subject matter described herein provides a description of a search tool for filtering search results that may, for instance, be leveraged by websites or mobile applications associated with online real estate services to enhance user experience by allowing users to conduct searches in a more intuitive manner. In particular, such websites or mobile applications may be able to leverage the techniques described herein to provide their users with a map-based polygonal search function that is accurate and relatively computationally inexpensive on the backend.

In some aspects, the subject matter described in this specification may be embodied in methods that may include the actions of receiving, at a computer system, data identifying a polygon with a plurality of edges that are connected and enclose one or more spatial regions, the polygon being positioned on a coordinate system, identifying, by the computer system, a plurality of lines to represent the polygon based on the plurality of edges, accessing, by the computer system, information that identifies a spatial record positioned at a location on the coordinate system using a spatial index that includes spatial data and non-spatial data, generating, by the computer system, a ray that emanates from the spatial record and that is projected in a particular direction, determining, by the computer system, whether the location of spatial record is included, at least partially, within the one or more spatial regions based, at least in part, on a number of times that the ray intersects the plurality of lines, and outputting, by the computer system, information that identifies whether the spatial record located, at least partially, inside of the polygon based on the determination.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. In some implementations, the spatial record is determined to be located, at least partially, inside of the polygon based on the ray intersecting the plurality of lines an odd number of times.

In some examples, the spatial record is determined to be located, at least partially, outside of the polygon based on the ray intersecting the plurality of lines an even number of times. In some implementations, lines that are parallel to the ray are excluded from a count of the number of times that the ray intersects the plurality of lines. In some examples, the particular direction is a substantially horizontal direction or a substantially vertical direction across the coordinate system.

In some implementations, identifying the plurality of lines may include segmenting, by the computer system, the polygon into a plurality of subparts, generating, by the computer system, a plurality of line sets for the plurality of subparts, each of the plurality of line sets including one or more lines that define a portion of the one or more spatial regions that is contained within a corresponding one of the plurality of subparts, and adding, by the computer system, lines from the plurality of line sets to the plurality of lines. In addition, a subpart that does not include an edge intersecting a perimeter of the subpart is, in some examples, excluded from the generating and the adding. In some examples, a line parallel to the ray is excluded from and not added to the plurality of lines. The plurality of subparts may, in some of such implementations, include a plurality of cells within a bounding box for the polygon. In some examples, the coordinate system is a Cartesian coordinate system.

In some implementations, the subject matter described in this specification may be embodied in search engine system comprising a search corpus database that includes at least one index of a plurality of records, each record including spatial data identifying a location within a geographic reference frame and non-spatial data; and a location-based search engine in data communication with the search corpus to execute searches thereon, the location-based search engine to perform operations comprising: receiving a definition of a geographic area in the geographic reference frame, the definition including a plurality of boundaries of the geographic area and, for each record of the plurality of records, casting a ray within the geographic reference frame, wherein the ray emanates from the location within the geographic reference frame identified by the spatial data, counting a number of intersections of the ray with the boundaries, determining, based on the number count of the intersections, whether the location identified by the spatial data is within the geographic area, and outputting an indication of whether the location is within the geographic area, wherein each ray has a same direction within the geographic reference frame.

Other implementations of this and other aspects include corresponding apparatus and computer programs configured to perform the actions of the operations performed by the search engine system. In addition, other implementations also include methods that perform the actions of the operations performed by the search engine system.

These other versions may each optionally include one or more of the following features. In some implementations, the index solely indexes the spatial data and an identifier of the record.

In some implementations, the index indexes both the spatial data and at least some of the non-spatial data.

In some implementations, for each record of the plurality of records, the location-based search engine determines that the location is within the geographic area in response to the number of intersections being an odd number.

In some implementations, for each record of the plurality of records, the location-based search engine determines that the location is outside the geographic area in response to the number of intersections being an even number.

In some implementations, the search engine system further comprises a web crawler to extract the spatial data and the non-spatial data from a plurality of web pages, and an indexer to receive the extracted the spatial data and the non-spatial data from the web crawler and index at least the spatial data within the index.

In some implementations, the geographic reference frame is a two-dimensional reference frame, the geographic area is a polygonal area, and the boundaries are edges of the polygonal area.

In some implementations, the rays are lines within the two-dimensional reference frame, and the direction of the rays is a direction having a slope of zero or a slope of one.

In some implementations, the operations performed by the location-based search engine further comprise performing a subsequent search of the records that include spatial data identifying locations within the geographic area, wherein the subsequent search compares the non-spatial data to one or more search parameters.

The subject matter described in this specification can be implemented in particular embodiments so as to realize one or more of the following advantages. For example, the subject matter described by this specification provides a location-based search system that facilitates search and retrieval of spatial records based on a polygon search using a spatial index that indexes spatial data and non-spatial data. This spatial index that indexes spatial data and non-spatial data improves the execution of a computer system executing a spatial search based upon a received polygon. This spatial index that indexes spatial data and non-spatial data allows for spatial records to be filtered out based on non-spatial search criterions (e.g., price, number of bedrooms, number of bathrooms, one or more product specifications, or the like) before execution of one or more subsequent processing stages that are computationally expensive such as ray casting operations. This filtering of spatial resources/records prior to performing subsequent processing stages that are computationally expensive reduces the amount of Central Processing Unit (CPU) resources, memory resources, bandwidth, and power, used by a computing system performing a spatial records search based on a received polygon using the spatial index disclosed by this specification. Moreover, since the number of spatial records that are identified for subsequent processing stages that are computationally expensive can be filtered, and the number of records processed by these subsequent stage reduced, execution time of a polygon search is also reduced. This results in a computer system that can perform a spatial records search based on a received polygon in a manner that is faster than conventional spatial search methods.

The details of one or more implementations are set forth in the accompanying drawings and the description below. Other potential features and advantages will become apparent from the description, the drawings, and the claims.

### BRIEF DESCRIPTION OF THE DRAWINGS

FIGS. 1 and 2 illustrate example search engine systems for determining whether a spatial record is located within a polygon.

FIG. 3 is a flowchart of an exemplary process for determining whether a spatial record is located within a polygon.

FIG. 4 is a diagram of exemplary computing devices.

Like reference symbols in the various drawings indicate like elements.

### DETAILED DESCRIPTION

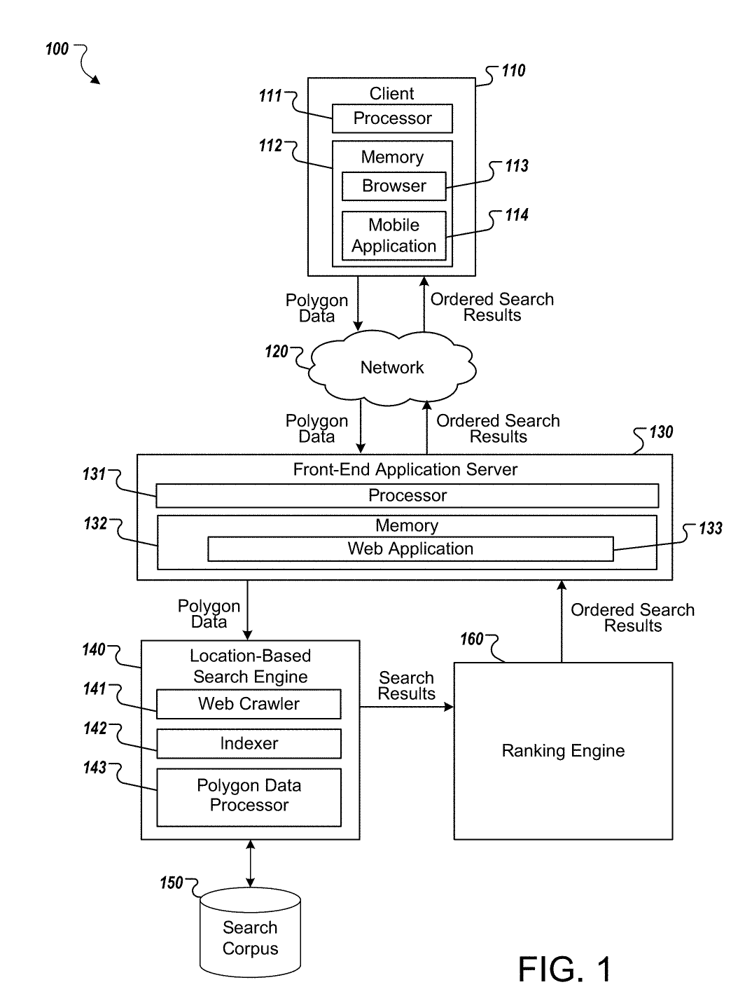

FIG. 1 depicts an example search engine system 100 for determining whether a spatial record is located within a polygon. The system 100 may include a client device 110, a network 120, a front-end application server 130, a location-based search engine 140, a search corpus database 150, a ranking engine 160, and a value estimation engine 170.

Client device 110 may be representative of one, or multiple, client devices. The client device 110 may include a mobile computing platform or a non-mobile computing platform. Mobile computing platforms may include, for example, a smartphone, tablet, laptop computer, or other thin client devices. Non-mobile computing platforms may include, for example, desktop computers, set top box entertainment systems, video game consoles, or the like. Client device 110 may be configured to communicate with front-end application server 130 via network 120 using one or more communication protocols.

The client device 110 of system 100 may include at least a processor 111 and a memory 112. The memory 112 may provide for the storage of computer program code associated with one or more applications installed on client 110. The applications may include, for example, a browser 113 or mobile application 114. Processor 111 may be configured to execute the stored computer program code in a manner that allows client 110 to realize the functionality provided by the applications. Processor 111 may also be configured to execute instructions to realize the functionality associated with any of the actions attributed to client 110 below.

The client 110 may be able to access one or more web based applications 133 hosted by front-end application server 130 via network 120 using browser 113. Such web based applications may include, for example, an application that facilitates identification of resources or records that include information for one or more properties/units or other entities that may be available for sale, for lease, or that provide a particular service. An entity may include any item that may be available for sale or lease such as, for example, a book, a clothing item, a motor vehicle, a consumer electronic item, a house, an apartment, or the like. Alternatively, an entity may include a party that provides a service such as, for example, a restaurant, a barber shop, a day care facility, a school, a doctor's office, a law office, a government agency, or the like. Web application 133 may utilize one or more back-end components in order to identify one or more resources or records that include information for one or more entities based on search input parameters. In certain instances, web application 133 may utilize the methods set forth herein to identify a set of one or more resources that are responsive to a query and include listing information for one or more properties, or information for one or more other entities.

Identification of resources or records may be achieved by using client device 110 to search one or more databases such as, for example, search corpus database 150 and then using one or more back-end components to identify and return ordered search results to client device 110. In some examples, the returned search results include graphical and/or textual representations of corresponding resources or records and the information included in the corresponding resources or records. A user may initiate a search with client device 110 by interacting with a map provided by a graphical user interface of web application 133 via a browser 113. For example, a user may input a search query by drawing one or more polygons or other shapes around a location of interest on such a map. Such polygons may, for instance, be effectively drawn by way of interaction between one or more components of client device 110 and the user's finger(s), a stylus, and/or another pointing device. In some implementations, such a map may be annotated with graphical indicia that reflect the edges of one or more polygons or portions thereof that the user of client device 110 has drawn or is currently drawing. For example, such graphical indicia may correspond to an outline of one or more polygons or portions thereof that the user of client device 110 has drawn or is currently drawing.

Client device 110 may then generate a query to identify resources or records that include listing information for one or more properties that may reside within geographic locations associated with the one or more polygons or other shapes drawn by the user on the map provided by such a graphical user interface. In some instances, the client device 110 may generate a query based on one or more user-drawn polygons and/or user input having been provided into one or more search fields provided by web application 133 via a browser 113. Upon generating a search query, client device 110 may transmit the search query to front-end application server 130 over network 120.

The search query that is sent to front-end application server 130 over network 120 may, in some instances, represent or include data that identifies one or more polygons having been drawn by a user of client device 110. The backend system may identify a set of search results in response to the search query, such as a set of resources/records that include listing information for one or more properties that are geographically-located within the boundaries of one or more polygons identified in the received search query, rank each search result in the set of search results, and then return the set of search results that are responsive to the received query to the front-end application server 130. The front-end application server 130 may then forward the search results back to client device 110.

The search results may be displayed on a graphical user interface associated with client device 110 in a variety of different ways that may assist a user in understanding and interpreting the search results. For instance, representations of the search results may be displayed as a list, where each representation in the list is ordered according to a rank determined by one or more backend components of system 100 such as, for example, ranking engine 160. Alternatively, or additionally, the search results may be represented as graphical icons that are plotted on a map of a geographical area and each correspond to a particular resource identified as a search result that is responsive to a received search query. The location of each graphical icon on the map may be indicative of the location of one or more properties for which the corresponding resource includes listing information. Such a map may, for instance, correspond to a map onto which one or more polygons identified by the received search query were previously drawn by a user of client device 110. In some examples, graphical icons may be presented on the map along with graphical indicia that reflects one or more polygons identified by the received search query were previously drawn by a user of client device 110, such that each graphical icon is shown as being located within the boundaries of at least one of such one or more polygons. In certain instances, search results may be displayed as both a ranked list in a first portion of the graphical user interface and as a plot of graphical icons on a map in a second portion of the graphical user interface. Other ways of displaying search results also fall within the scope of this specification.

Separate from browser 113, a client device 110 may also be able to use a mobile application 114 in order for a user of client device 110 to avail himself of the same, or similar, functionality that was described above as being provided by a web application 133 via browser 113. Mobile application 114 may include an executable software program that was previously downloaded from a mobile application provider. Mobile application 114 may be configured to relay commands input by a user such as, for example, search queries that represent or include polygon data to the front-end application server 130. After receiving a search query from mobile application 114, the front-end application server 130 may request that one or more backend components execute the search query, rank the search results, and then return the ranked search results to mobile application 114, which may display the search results as a ranked list of resources or records that each include listing information for one or more properties, as plotted graphical icons on a map, or a combination thereof.

Network 120 may be configured to facilitate connectivity between a client device 110 and the front-end application server 130. Client 110 and front-end application server 130 may be connected to network 120 via one or more wired, or wireless, communication links. Network 120 may include any combination of one or more types of public and/or private networks including but not limited to a local area network (LAN), wide area network (WAN), the Internet, a cellular data network, or any combination thereof.

Front-end application server 130 may include at least a processor 131 and a memory 132. The memory 132 may provide for the storage of computer program code associated with one or more applications hosted by front-end application server 130. The applications may include, for example, a web application 133 that may facilitate identification of resources or records that include listing information for one or more particular properties that may be available for sale, for lease, or that provide a particular service. Processor 131 may be configured to execute the stored computer program code in a manner that allows front-end application server 130 to realize the functionality provided by the applications. Processor 131 may also be configured to execute instructions to realize the functionality associated with any of the actions attributed to front-end application server 130 below.

Front-end application server 130 may serve as an interface between the client 110 and the back-end components of system 100 that may include, for example, a location-based search engine 140, search corpus database 150, ranking engine 160, and value estimation engine 170. Front-end application server 130 may be comprised of one or more server computers. Front-end application server 130 may be configured to receive commands from a client device 110, and translate those commands, if necessary, into a format that is compatible with one or more back-end network components. Front-end application server 130 may also employ network security applications such as, for example, a firewall, user authentication, subscription verification, or the like in an effort to supervise access to one or more back-end network components, if necessary.

Front-end application server 130 may also facilitate session management for each browsing session initiated by each respective client device 110 that is currently using a browser 113, or mobile application 114, to avail itself of the services provided by the web application 133. For instance, front-end application server 130 may employ functionality to associate an identifier with each query received by the front-end application server 130 from a particular client 110. The front-end application server 130 may later utilize the identifier in order to associate ordered search results received from a ranking engine 160 with a query received from a particular client 110. The identifier may then be used to return the set of ordered search results to the client device 110 that initiated the query. The identifier may include a user identifier, device identifier, transaction identifier, or the like.

System 100 may also include a location-based search engine 140. Location-based search engine 140 may be configured to receive and execute search queries that are associated with a location component. The location component of the search query may, for instance, correspond to one or more geographic locations enclosed by one or more polygons or other shapes having been drawn by a user via client device 110.

Location-based search engine 140 may include a web crawler 141, an indexer 142, and a polygon data processor 143. The location-based search engine 140 may be hosted by one or multiple server computers. The server computer(s) hosting the location-based search engine 140 may be the same server computer(s) that provide the front-end application server 130. Alternatively, however, the server computer(s) hosting the location-based search engine 140 may be a different set of one or more server computer(s) that are configured to communicate with the front-end application server 130 via one or more public or private networks.

Web crawler 141 may be configured to traverse computers connected to a computer network such as, for example, the Internet, to scan and identify data associated with particular properties. For instance, web crawler 141 may scan computers associated with a computer network in order to identify resources or records such as web pages and other files accessible via the computer network that may include data associated with one or multiple properties that are currently being offered for sale or lease. Alternatively, or in addition, web crawler 141 may scan computers associated with a computer network in order to identify resources or records that may include data associated with one or more services. The identified resources or records or a subset of the raw data associated therewith may be stored in search corpus database 150. In some implementations, web crawler 141 may be autonomous software that is configured to periodically scan computer networks in order to identify new, or previously undiscovered, web pages, network accessible files, or other resources or records associated with one or more properties that are currently being offered for sale, for lease, or resources or records associated with one or more services. Alternatively, or in addition, the functionality of web crawler 141 may be performed by one or more operators of location-based search engine 140. For instance, a group of one or more analysts may obtain raw data associated with a property, and store the raw data in search corpus database 150. Alternatively, or in addition, it is contemplated that a party that offers a property for sale, for lease, or that provides a service may also upload raw data associated with the property to search corpus database 150.

The aggregated set of raw data stored in search corpus database 150 may comprise a wealth of data describing a wide spectrum of different properties. For instance, search corpus database 150 may include data for each known property that indicates, for example, the name of the property, the property's location, a description of the property, a value associated with the property, or the like. In some examples, data that indicates the property's location may include one or more sets of geographic coordinates or other geographic data from which one or more sets of geographic coordinates may be derived. For instance, the property's location may be represented by one or more sets of latitudinal, longitudinal, and/or elevation coordinates. The value for the property may include, for example, the price of a property that is being offered for sale or for lease. Alternatively, however, the value for a property may include, for example, a property rating. Other types of raw data associated with a property may be obtained via the data crawling process and stored in search corpus database 150.

In some examples, search corpus database 150 may be a relational database in which data is logically organized into a series of database tables. In such examples, one or more components of location-based search engine 140, such as web crawler 141 and indexer 142, may operate in conjunction with search corpus database 150 as a relational database management system (“RDBMS”). In these examples, each database table in search corpus database 150 may arrange data in a series of columns (where each column represents an attribute of the data stored in the database) and rows (where each row represents attribute values). In some implementations, search corpus database 150 may be an object-oriented database in which data is logically or physically organized into a series of objects. In such implementations, one or more components of location-based search engine 140, such as web crawler 141 and indexer 142, may operate in conjunction with search corpus database 150 to manage such objects. Each object may be associated with a series of attribute values. In some examples, search corpus database 150 may be a type of database management system that is not necessarily a relational or object-oriented database. For example, a series of files or documents may be used, where each file or document is encoded in JavaScript Object Notation (“JSON”) or Extensible Mark-up Language (“XML”) and includes attributes and attribute values. Data included in search corpus database 150 may be identified by a unique identifier such that data related to a particular process may be retrieved from search corpus database 150.

Indexer 142 may be configured to analyze the raw data obtained during the crawling process in order to make the raw data searchable. For instance, indexer 142 parse the raw data and extract one or more types of relevant data. For example, the indexer 142 may analyze the raw data to extract a property's name, a property's location, and a value associated with the property. Indexer 142 may then associate the extracted data with one or more keywords. The associated keywords may be compared to aspects of received search queries in order to determine whether the extracted data associated with the keywords is responsive to the search query.

In some implementations, indexer 142 may further associate each property's location, as represented by one or more sets of geographic coordinates, with one or more keywords and/or additional sets of geographic coordinates. For instance, indexer 142 may associate a given property's location with keywords that represent one or more geographic regions within which the given property is located and/or four or more sets of geographic coordinates that define vertices or points along boundaries of one or more geographic regions within which the given property is located. In some instances, each of the one or more geographic regions with which indexer 142 associates a given property may serve to represent the given property's location on a different geographic scale. For example, indexer 142 may associate a given property with keywords including the name of the neighborhood within which the given property is located, the name of the borough within which that neighborhood is located, the name of the city within that borough is located, the name of the state within which that city is located, and so on. Similarly, indexer 142 may, for instance, associate a given property with various different sets of geographic coordinates including four or more sets of geographic coordinates that define a first geographic quadrangle within which the given property is located, four or more sets of geographic coordinates that define a second, larger geographic quadrangle within which the first geographic quadrangle is located, four or more sets of geographic coordinates that define a third, even larger geographic quadrangle within which the second geographic quadrangle is located, and so on. In this way, indexer 142 may enable properties to be identified through location-based searches conducted on a variety of different geographic scales.

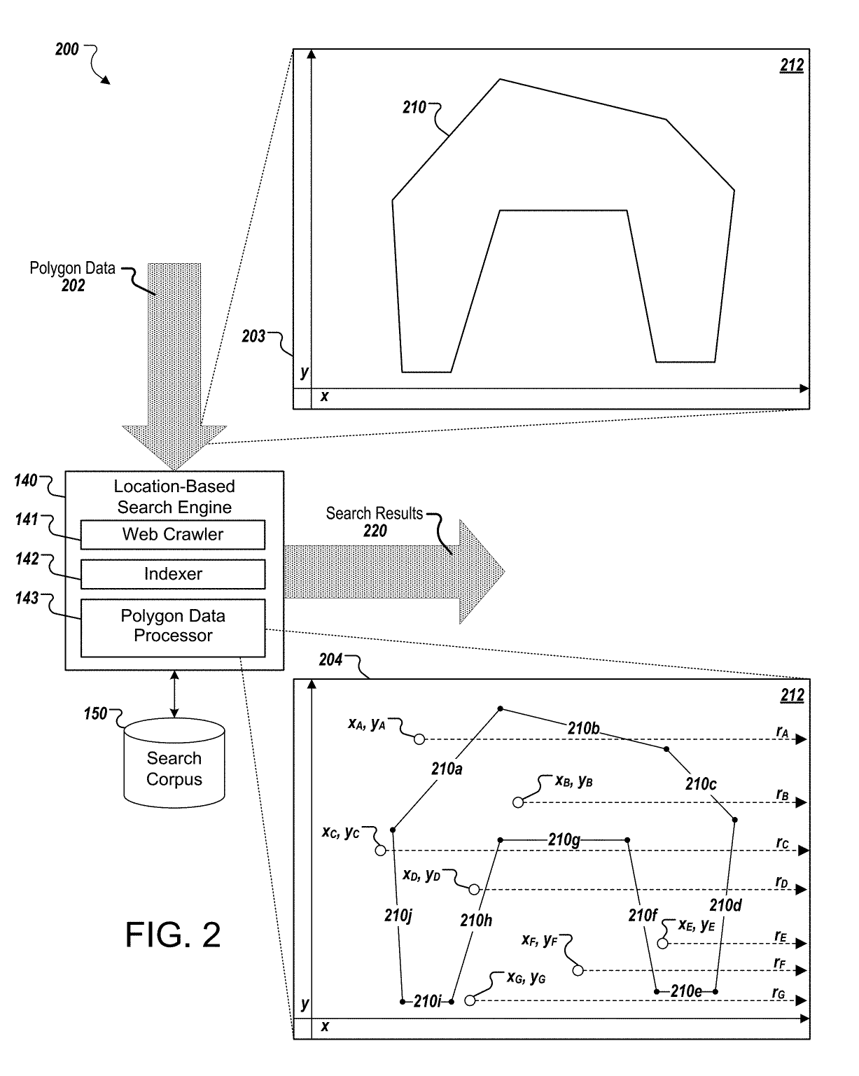

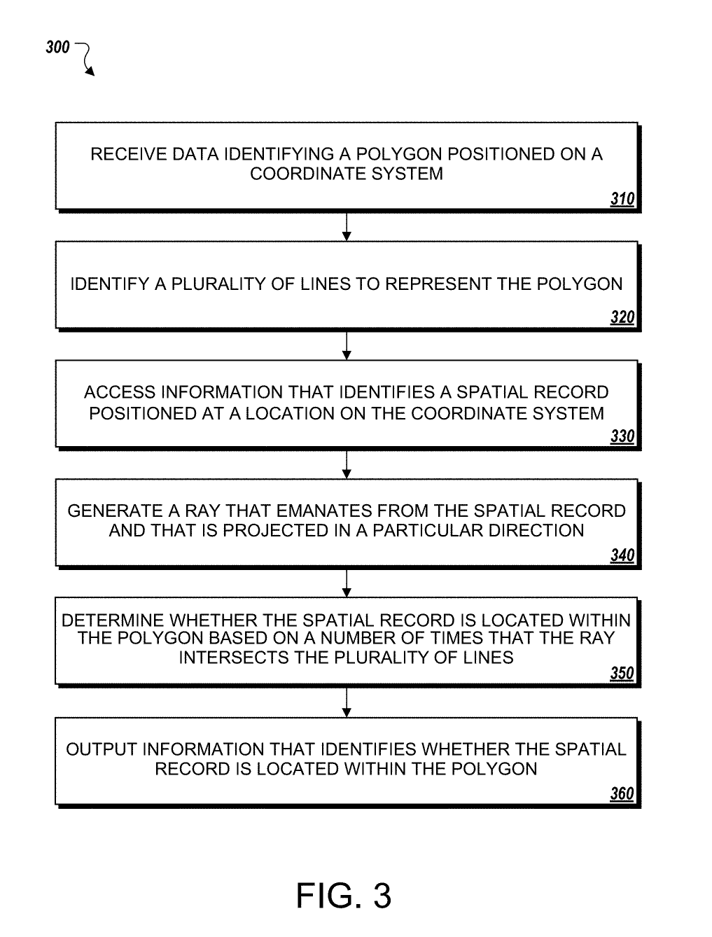

Polygon data processor 143 may be configured to receive a search query from front-end application server 130 that originated at client device 110, identify one or more polygons that are associated with the search query, and perform one or more operations to identify indexed resources/records that include listing information for one or more properties that are located within the one or more polygons. The one or more operations that are performed by polygon data process 143 are described in further detail in the discussions of FIGS. 2 and 3 below. At least a portion of the resources/records that are identified by polygon data processor 143 as being located within one or more polygons that are associated with the search query may, in some examples, serve as search results that are ultimately provided to client device 110 responsive to search query submission. In some examples, polygon data processor 143 may also be configured to identify non-polygonal search filters or other parameters that are associated with the search query, such as user-submitted keywords that are included as part of the search query, and apply such parameters against the index generated by indexer 142 before and/or after performing one or more operations to identify indexed resources/records that include listing information for one or more properties that are located within one or more polygons that are associated with the search query.

The search results may identify, for example, a group of one or multiple links that are associated with resources or records that are responsive to the query received from client 110. The search result links may reference a resource that includes information associated with one or more properties. For instance, the search result links may reference web pages that include listing information for one or more properties. The information included in each resource may be drawn from search corpus database 150. The set of search results may be substantially unordered, or otherwise arranged in an order that is not based on entity value. The search results identified by the polygon data processor 143 in response to the received search query may then be passed to the ranking engine 160. The location-based search engine 140 may communicate with the ranking engine using one or more public or private networks.

System 100 may also include a ranking engine 160. Ranking engine 160 may be hosted by one or multiple server computers. The server computer(s) hosting the ranking engine 160 may be the same server computer(s) that provide the front application server 130. Alternatively, however, the server computer(s) hosting the location-based ranking engine 160 may be a different set of one or more server computer(s) that are configured to communicate with the front-end application server 130 via one or more public or private networks.

Ranking engine 160 may be configured to perform a series of post processing operations on the set of identified search results. The post processing operations may determine a ranking score that may be associated with each resource in the set of search resources or records based at least on the analysis of a metric associated with each entity responsive to a query. For instance, a ranking score may be determined for a particular resource based on the amount of time that has elapsed since the particular resource has been updated, the availability of one or more properties for which the particular resource includes listing information, the interface through which the particular resource's listing information is supplied and/or modified, the value by which one or more properties associated with the listing information of the particular resource exceed the maximum desired value, various verifications associated with the particular resource and properties, or a combination thereof. Ranking engine 160 may utilize make such determinations based on information provided by location-based search engine 140, information included in search corpus 150, historical information that is managed or accessed by ranking engine 160, and the like. Ranking engine 160 may then return the set of ordered results to the front-end application server 130 via one or more public or private networks. Front-end application server may then provide the ordered search results to client device 110 via network 120.

Ranking engine 160 may be configured to isolate and analyze search results based on a predetermined geographic region. A geographic region may include, for example, a neighborhood, a city, a state, a zip code, GPS coordinates, longitude and latitude coordinates, a shape drawn by a user on a graphical user interface map, or the like. Once a set of search results are isolated by geographic region, the ranking engine may analyze characteristics each resource and the one or more properties for which each resource includes listing information. For instance, the ranking engine 160 may determine how much time has elapsed since the particular resource was last updated, whether one or more properties for which the particular resource includes listing information are currently available or will become available within an upcoming timeframe, whether the information included in the particular resource is supplied manually through a user interface or automatically through an application programming interface, whether one or more properties for which the particular resource includes listing information have prices that exceed a specified price range, whether any attributes of the particular resource or one or more properties associated with the particular resource, and the like. Ranking engine 160 may utilize make such determinations based on information provided by location-based search engine 140, information included in search corpus 150, historical information that is managed or accessed by ranking engine 160, and the like. Ranking engine 160 may assign a score to each resource identified as responsive a given search query.

Ranking engine 160 may be configured to make one or more determinations about a particular resource and assign a ranking score based on such determinations, as appropriate. The ranking engine 160 may rank a set of resources or records based on the ranking score assigned to each resource in the set of resources or records. In some examples, the ranking engine 160 may, before making one or more of such determinations, determine a ranking score for a particular resource based on default criteria such as an initial search ranking score and, after making one or more subsequent ranking determinations, adjusting the initial search ranking score for the particular resource based on one or more of such subsequent ranking determinations. Initial ranking scores, subsequent ranking scores, or both, may be based on a number of factors including geographic location, popularity, placement in search result rankings, recency of the search result (e.g., based an amount of time the resource or record has been searchable, an amount of time since the resource or record has been updated, or the like), or the like. In some implementations, it may be beneficial to assign ranking scores in a manner that favors resources or records that include information that has been recently updated over resources or records that include information that has less recently been updated. In this way, users may be presented with listing information that is known to be relatively fresh and up-to-date, which may be especially important in competitive rental markets.

In some aspects of the present disclosure, ranking engine 160 may be utilized only when requested by a user of client device 110. If a user decides to not use ranking engine 160, the search results may be provided to the client device in the order determined by location search engine 140. Such order may be, for example, based on most expensive price, lowest price, based on an analysis of keyword frequency in a web page associated with the search result corresponding to the entity, based on payments received to increase a ranking score associated with each entity, or the like, or any combination thereof. Accordingly, client 110 may be able to toggle ranking engine 160 on and off. In some instances, client 110 may be able to adjust ranking engine 160 such that ranking scores are assigned based on specific characteristics of resources or records.

FIG. 2 depicts an example search engine system 200 for determining whether a spatial record is located within a polygon. Search engine system 200 may, for example, include one or more components that are representative of one or more components of search engine system 100, as described above in reference to FIG. 1. In particular, search engine system 200 may include components that correspond to location-based search engine 140, which includes web crawler 141, indexer 142, and polygon data processor 143, as well as search corpus database 150.

In the example of FIG. 2, it can be seen that location-based search engine 140 may receive polygon data 202. In some implementations, polygon data 202 may identify one or more user-defined polygons provided through a client device that directly or indirectly communicates with search engine system 200, such as client device 110 as described above in reference to FIG. 1. It follows that, in some of such implementations, location-based search engine 140 may receive the polygon data 202 from a front-end application server, such as front-end application server 130 as described above in reference to FIG. 1. In some implementations, the location-based search engine 140 may also receive a non-spatial search criterion (or search criteria). For example, the computer system may also receive non-spatial search criterion (or search criteria) related to a real-estate listing such as a number of bedrooms, number of bathrooms, price range, or the like. The received non-spatial search criterion (or search criteria) may be received from a user profile, a predefined user search criterion (or search criteria), one or more query parameters entered into one or more search fields by the user in addition to inputting of the polygon, or the like. The non-spatial search criterion (or search criteria) may be input before, after, or during (e.g., a voice command input while drawing a polygon) inputting of the polygon.

As shown at 203, polygon data 202 may identify a polygon 210 that is positioned on a coordinate system 212. Polygon 210 may, for instance, represent a polygon having been provided by a user through a graphical user interface and onto a map of the graphical user interface so as to define a custom geographic region within which one or more properties to be identified by search engine system 200 are to be geographically located. The coordinate system 212 may, for example, define coordinates, such as Cartesian coordinates, for a finite quantity of points in two dimensional space. In some examples, each point in such a finite quantity of points may correspond to a different pixel of the map of the graphical user interface onto which one or more polygons or shapes, such as polygon 210, have been drawn. In this way, the coordinate system 212 may be seen as corresponding to a geographical coordinate system. It follows that, in such examples, the amount of geographical area that is represented by each pixel of the map, and thus each set of coordinates defined by coordinate system 212, directly depends upon the amount of geographical area that is represented by the map as presented through the graphical user interface. For instance, each pixel of a map that, as presented through a graphical user interface, represents an entire country, may represent a different city located within that country, while each pixel of another map that, as presented through a graphical user interface, only represents one city, may represent a different neighborhood or block of that one city.

Polygon data 202 may, for instance, identify each of one or more coordinates defined by coordinate system 212 at which each of one or more edges of polygon 210 are positioned. That is, polygon data 202 may effectively represent polygon 210 using coordinates defined by coordinate system 212. In some examples, polygon data 202 may represent polygon 210 using a set of bounded line segments that are, for instance, each described as linear functions. In some implementations, polygon data 202 may also identify the geographic coordinates to which polygon 210 corresponds. For instance, polygon data 202 may directly or indirectly identify the geographic coordinates of the particular geographic locations on the map along which polygon 210 was drawn. The identified geographic coordinates can be used to identify respective entries of a spatial index of respective real-estate properties stored in the search corpus 150. The real-estate properties may include apartments, single-family homes, townhomes, commercial buildings, industrial buildings, or the like that may be available for rent, for lease, for sale, or the like.

Upon receiving polygon data 202, location-based search engine 140 may determine the geographic coordinates to which polygon 210 corresponds and perform one or more operations to identify resources/records that include listing information for one or more properties that are located within the confines of the geographic coordinates to which polygon 210 corresponds. Polygon data processor 143 may, for instance, identify a plurality of lines, as described using coordinates defined by coordinate system 212 and/or the corresponding geographic coordinates, to represent polygon 210. For example, such a plurality of lines identified for polygon 210 may correspond to line segments 210a-210j, as shown at 204. Furthermore, polygon data processor 143 may determine that polygon 210 falls within a particular set of predefined geographic regions, such as quadrangles or cells that are formed between intersecting lines of latitude and longitude that occur at discrete intervals of geographical distance. Polygon data processor 143 may, for instance, initially determine the quadrangles that polygon 210 falls within using lines of latitude and longitude that occur at relatively large intervals of geographical distance, and thus represent the geographic regions within which polygon 210 is located with a relatively low level of resolution. In some examples, polygon data processor 143 may initially determine a bounding box for polygon 210, and then identify each quadrangle within which the bounding box for polygon 210 is at least partially located. In other examples, polygon data processor 143 may determine such quadrangles by identifying the lines of latitude and longitude that intersect the plurality of lines representing polygon 210.

The search corpus database 150 may include one or more indices that can be used to identify quadrangles within the bounding box for the polygon 210, real-estate property listing information corresponding to properties geographically located within the quadrangles, or both. In some implementations, computational resources (e.g., CPU power, memory usage, power usage, or a combination thereof) required to execute a polygon search can be reduced by using the same index for spatial information (e.g., geographic data identifying a quadrangle (or cell), quadrangle (or cell) identifiers, or the like) and non-spatial information (e.g., real-estate property listing information such as number of bedrooms, number of bathrooms, a property price, or the like). Use of the same index for both spatial and non-spatial information reduces the amount of computational resources required to execute a polygon search by reducing the number of relevant real-estate property listings within the bounding box that require one or more additional stages of subsequent processing described below. The number of relevant real estate property listings are reduced because this initial set of real-estate property listings can be filtered using one or more search parameters (e.g., property value, number of bedrooms, or the like) that may be submitted in addition to the polygon. For example, a resource/record corresponding to a real-estate property that otherwise potentially falls within the bounding box of the polygon may be excluded from further processing during the subsequent ray-casting stages if it is determined, based on a search of the spatial index including both spatial data and non-spatial data, that the real-estate property is not associated with a price that falls within a price range received as a non-spatial search criterion from the user. Moreover, since real-estate property listing data is already included in the index, additional computationally expensive lookups to real-estate listing database do not need to be performed once processing of the polygon search is complete. For at least these reasons, executing a polygon search using an index that includes both spatial and non-spatial data is significantly more computationally efficient than executing a polygon search using separate respective indices for spatial data and non-spatial data.

Upon determining the particular set of quadrangles within which polygon 210 is located, the location-based search engine 140 may use the one or more indices maintained in the search corpus database 150 to identify resources/records that include listing information for one or more properties that are located within the particular set of quadrangles. In some examples, each quadrangle may be associated with an identifier. In such examples, each resource/record may be stored and managed by search corpus database 150 and location-based search engine 140, respectively, in association with the identifier that corresponds to the quadrangle within which the one or more properties for which each resource/record includes listing information is located.

Since, as mentioned above, the quadrangles determined by polygon data processor 143 may be a relatively low resolution, it follows that one or more of such quadrangles may cover geographic area that is external to or outside of polygon 210. For this reason, it is possible that the location-based search engine 140 may identify resources/records that include listing information for one or more properties that are located within the particular set of quadrangles, but are not actually located within the confines of polygon 210.

Polygon data processor 143 may therefore perform one or more subsequent operations to determine whether such identified resources/records include listing information for one or more properties that are actually located within polygon 210. In the example of FIG. 2, location-based search engine 140 may, for instance, identify records A-G as including listing information for properties that are located within the same quadrangles as polygon 210. Records A through G may, for instance, each include listing information for properties at positions [x_{A},y_{A}] through [x_{G},y_{G}] within coordinate system 212, respectively, as shown at 204. In order to determine whether one or more of records A through G is truly located within polygon 210, polygon data processor 143 may perform one or more ray casting operations within coordinate system 212. In some implementations, the identified resources/records may be pre-filtered based on the one or more non-spatial search criterion (or search criteria) received from a user such number of bedrooms, number of bathrooms, price, or the like. In such instances, the ray casting operations described below may be avoided for resources/records that do not satisfy the received non-spatial search criterion (or search criteria). Such non-spatial a search criterion (or search criteria) can be used to search the non-spatial index that includes both spatial and non-spatial data and identify for further ray casting operations only those resources/records that fall within the polygon (or a quadrangle associated with the polygon) and satisfy the non-spatial search criterion (or search criteria).

As shown at 204, polygon data processor 143 may generate rays r_{A} through r_{G} that emanate from points [x_{A},y_{A}] through [x_{G},y_{G}], respectively, are projected in a particular direction. In the example of FIG. 2, the particular direction in which rays r_{A} through r_{G} that emanate from points [x_{A},y_{A}] through [x_{G},y_{G}], respectively, is a positive direction along the x-axis of coordinate system 212. Upon generating ray for each of records A through G, polygon data processor 143 may determine which, if any, of the plurality of identified lines 210a-210j that represent polygon 210 each of rays r_{A} through r_{G} intersect. Polygon data processor 143 may then be able to determine whether or not each one of records A through G includes listing information for a property that is located with polygon 210 based on such an intersection analysis. In some examples, polygon data processor 143 may determine whether each of rays r_{A} through r_{G} intersect one or more lines that are different from the plurality of identified lines 210a-210j. For instance, polygon data processor 143 may, in such examples, identify a set of points within coordinate system 212 at which outer edges of polygon 210 intersect with the borders that define each quadrangle having been identified for polygon 210. Polygon data processor 143 may then, for example, define lines that extend from each point in the set of identified points to the next. In a way, this may be seen as generating a plurality of lines that represent a sort of downsampled version of polygon 210. In these examples, fewer lines may be used to represent polygon 210, which may serve to reduce the computational, power, and/or communicative load that is placed on components of system 100 when performing one or more of the operations described herein.

The aforementioned rays may be generated so that they emanate in any direction using lines of any slope. However, in some implementations, the aforementioned rays may be generated in particular ways to increase the computational efficiency of the execution of the polygon search. For example, in some implementations, the aforementioned rays may be generated so that the rays only extend in the horizontal or vertical direction, but not both. The computational efficiency of the polygon search may be increased using horizontal rays because the polygon data process does not need to perform additional complex calculations based on the slope of the ray since the slope is zero. Similar gains in computational efficiency can also be achieved using vertical rays due to the reduction in complexity of additional complex calculations related to the slope since the slope is undefined. In addition, rays with a slope of 1 can also be used to increase the computational efficiency of the polygon search for the same reasons. Each of the aforementioned rays will result system that yields an increase computational efficiency of execution of a polygon search by using less processing resources, less memory resources, and less power resources than a system using rays having a slope falling between the values of zero and 1.

In some implementations, polygon data processor 143 may determine whether or not each one of records A through G includes listing information for a property that is located with polygon 210 based on the quantity of the plurality of identified lines 210a-210j that intersect each corresponding ray. For example, polygon data processor 143 may identify rays that intersect an odd number/quantity of lines 210a-210j as being located within polygon 210, and identify rays that intersect an even number/quantity of lines 210a-210j or do not intersect any of lines 210a-210j as being located outside of polygon 210. For instance, it can be seen that r_{A}, which emanates from point [x_{A},y_{A}] within coordinate system 212 to which record A corresponds and pass through a total of two of the plurality of lines that represent polygon 210 (i.e., lines 210a and 210b), indicates that point [x_{A},y_{A}] is located outside of polygon 210 by virtue of intersecting with an even number of the plurality of lines that represent polygon 210. On the other hand, it can be seen that r_{B}, which emanates from point [x_{B},y_{B}] within coordinate system 212 to which record A corresponds and pass through a total of one of the plurality of lines that represent polygon 210 (i.e., line 210c), indicates that point [x_{B},y_{B}] is located within polygon 210 by virtue of intersecting with an odd number of the plurality of lines that represent polygon 210. As described above, in some examples, such processes may be performed using lines that extend between each point within coordinate system 212 at which the outline of polygon 210 intersects with the outline of one of the one or more quadrangles having been identified for polygon 210 in place of lines 210a-210j.

Polygon data processor 143 may apply logic similar to that which has been described in the examples of r_{A} and r_{B} above to determine whether each of records C through G are located within polygon 210. It follows that, in this example, polygon data processor 143 may (i) determine that records B, D, and E are associated with properties that are located within polygon 210 based on determining that rays r_{B}, r_{D}, and r_{E} each intersect edges of polygon 210 an odd number of times, (ii) determine that records A, C, and F are associated with properties that are located outside of polygon 210 based on determining that rays r_{A}, r_{C}, and r_{F} each intersect edges of polygon 210 an even number of times, and (iii) determine that record G is associated with a property that is located outside of polygon 210 based on determining that ray r_{G} does not intersect any edges of polygon 210. For this reason, location-based search engine 140 may, for example, output search results 220 that reference records B, D, and E, but do not reference records A, C, F, or G. Such search results 220 may, for instance, be provided to one or more components not shown in FIG. 2, such as that which represents a ranking engine, such as ranking engine 160 as described above in reference to FIG. 1.

In some examples, location-based search engine 140 may apply one or more additional filters to such records before outputting search results 220. For example, location-based search engine 140 may determine that records B, D, and E are each located within polygon 210, but omit references to record D from search results 220 because the property associated with record D is determined to be outside of a user-defined price range. Such filters may be applied before or after performance of the ray-casting stages. For example, in some implementations, in order to achieve gains in computational efficiency, some or all of such filters may be applied prior to performing the ray casting operations described above by searching a spatial index that includes spatial data and non-spatial data. In such implementations, location-based search engine 140 may, in a situation similar to the example described above in which the property associated with record D is outside of a user-defined price range, simply eliminate record D from contention before performing ray casting operations and therefore not generate ray r_{D}. Alternatively, in other implementations, such filtering may be performed after the performance of the ray-casting stages. Upon providing search results 220, system 200 may perform one or more operations to store some or all of polygon data 202 and/or data having been derived or generated at system 200 through performing one or more of the operations described herein based on polygon data 202. In some examples, system 200 may store such data in association with an account that is registered to the user that drew polygon 210 and/or a client device through which polygon 210 was drawn.

Although polygon 210 has been described herein as representing a user-drawn polygon having been submitted as a search query, it is to be understood that the polygons and polygon data that may be processed by location-based search engine 140 may take a variety of other, different forms. For instance, polygon 210 may be a polygon that is generated by one or more components of system 100 and/or 200 independent from user-drawn input. In addition, it is to be noted that the techniques described herein may also be leveraged to determine whether points are located within multiple, different polygons, and even polygons with holes.

In some examples, system 100 and/or 200 may generate one or more polygons based on the location of a client device, such as client device 110 as described above in reference to FIG. 1, or some other location that the user of client device 110 has input as a search parameter. Such search parameters may, for instance, include keywords and/or selectable options that serve to indicate a location such as a neighborhood, a city, a state, a zip code, or the like. In such examples, system 100 and/or 200 may maintain or otherwise have access to one or more predefined polygons that represent geographic boundaries of a neighborhood, a city, a state, a zip code, or the like. In this way, system 100 and/or 200 may select, from among multiple different predefined polygons, a particular polygon that is determined to correspond to the location that the user of client device 110 has input as a search parameter. Such predefined polygons may, for example, be stored in search corpus database 150 or other electronic data storage to which system 100 and/or 200 has access.

Alternatively, or in addition, system 100 and/or 200 may generate one or more polygons based on one or more attributes associated with a client device 110. For instance, one of the aforementioned network components may determine the current location of a client device 110. Alternatively, the current location of a client device 110 may be provided to one or more network components of system 100 by a third party. Alternatively, or in addition, system 100 and/or 200 may generate one or more polygons based on locations that the client device 110 has recently traveled. System 100 and/or 200 may also generate polygons based on other information, such as a desired commute time as specified by the user.

In some implementations, some resources/records may be associated with multiple, different locations. For example, such resources/records may include information that represents a geographic area, and may thus be associated with multiple, different locations defining a polygon that encloses such a geographic area. In this way, system 100 and/or 200 may be able to determine whether polygon 210 overlaps with one or more other polygons of interest. Such polygons may, for example, include predefined polygons that represent geographic boundaries of a neighborhood, a city, a state, a zip code, or the like, such as those mentioned above, as well as one or more other polygons having been previously drawn by the user of client device 110 or other users of system 100 and/or 200. In order to determine whether portions of such other polygons are located within polygon 210, polygon data processor 143 may, in these implementations, generate rays that emanate from points that correspond to vertices of such other polygons. This technique may, for instance, be leveraged to provide analytics and/or visualizations that yield a variety of insights that may be of value to prospective tenants, property owners, property managers, real estate agents, investors, developers, and the like. For instance, this technique may be leveraged to produce heat map visualizations that serve to indicate the search popularity of various locations within a geographic region, based on the quantity of polygons that (i) are drawn by different users of system 100 and/or 200, and (ii) enclose each given location within the geographic region. In this way, such heat maps may indicate the most sought-after locations within a geographic location, as well as those that draw little-to-no interest from prospective tenants. The analytics that drive or are associated with such visualizations may, for instance, be useful when performing a valuation of one or more properties or pieces of land. In another example, the technique may be leveraged with one or more machine learning techniques to, for instance, identify and subsequently classify new and/or up-and-coming neighborhoods that are not currently recognized as a standalone neighborhoods, predict how popular newly-constructed residences and/or newly-developed areas might be based on one or more characteristics of such residences and/or areas and one or more characteristics of already-established residences and/or areas, identify geographic regions and characteristics of geographic regions that are of general interest or disinterest to particular user demographics, recognize societal trends, and the like.

Though location-based search engine is described above with reference to searching and retrieving data associated with listings for real-estate properties, the present disclosure need not be so limited. For example, any type of object for sale or lease that has a corresponding geographic location can be searched and retrieved using the present disclosure. Types of objects that may be searched and retrieved using the techniques here include real-estate properties, consumer electronics devices (e.g., smartphones, tablets, laptops, desktops, etc), books, automobiles, or the like. The objects may be new or used.

FIG. 3 illustrates exemplary process 300 for determining whether a spatial record is located within a polygon. The following describes the process 300 as being performed by components of system 100 described above with reference to FIG. 1 and/or system 200 described above with reference to FIG. 2. However, the process 300 may be performed by other systems or system configurations. Briefly, the process 300 may include receiving data identifying a polygon positions on a coordinate system (310), identifying a plurality of lines to represent the polygon (320), accessing information that identifies a spatial record position at a location on the coordinate system using a spatial index that includes spatial data and non-spatial data (330), generating a ray that emanates from the spatial record and that is projected in a particular direction (340), determining whether the spatial record is located within the polygon based on a number of times that the ray intersects the plurality of lines (350), and outputting information that identifies whether the spatial record is located within the polygon (360).

In more detail, process 300 may include receiving, at a computer system, data identifying a polygon with a plurality of edges that are connected and enclose one or more spatial regions, the polygon being positioned on a coordinate system (310). This may, for instance, correspond to one or more components of system 100 and/or 200, such as front-end application server 130 and/or location-based search engine 140 as described above in reference to FIGS. 1 and 2, receiving polygon data, such as polygon data 202 that identifies polygon 210 positioned on coordinate system 212. In some examples, the coordinate system on which the polygon is positioned may be that of a Cartesian coordinate system. In some implementations, the non-spatial search criteria may also be received at stage 310. For example, the computer system may also receive non-spatial search criterion (or search criteria) related to a real-estate listing such as a number of bedrooms, number of bathrooms, price range, or the like. The received non-spatial search criterion (or search criteria) may be received from a user profile, a predefined user search criterion (or search criteria), one or more query parameters entered into one or more search fields by the user in addition to inputting of the polygon, or the like. The non-spatial search criterion (or search criteria) may be input before, after, or during (e.g., a voice command input while drawing a polygon) inputting of the polygon.

The process 300 may include identifying, by the computer system, a plurality of lines to represent the polygon based on the plurality of edges (320). This may, for instance, correspond to one or more components of system 100 and/or 200, such as polygon data processor 143 of location-based search engine 140 as described above in reference to FIGS. 1 and 2, identifying a plurality of lines 210a-210j to represent polygon 210. In some examples, this may instead correspond to one or more components of system 100 and/or 200, such as polygon data processor 143 of location-based search engine 140 as described above in reference to FIGS. 1 and 2, identifying a plurality of lines that extend between each point within coordinate system 212 at which the outline of polygon 210 intersects with the outline of one of the one or more quadrangles having been identified for polygon 210.

In some implementations, identifying the plurality of lines may include segmenting, by the computer system, the polygon into a plurality of subparts, generating, by the computer system, a plurality of line sets for the plurality of subparts, each of the plurality of line sets including one or more lines that define a portion of the one or more spatial regions that is contained within a corresponding one of the plurality of subparts, and adding, by the computer system, lines from the plurality of line sets to the plurality of lines. This may, for instance, correspond to one or more components of system 100 and/or 200, such as polygon data processor 143 of location-based search engine 140 as described above in reference to FIGS. 1 and 2, identifying multiple, different quadrangles within at least a subset of which one or more portions of polygon 210 are located. In the example of FIG. 2, polygon 210 may, in such implementations, be segmented or divided into subparts by a predefined set of lines, such as lines of latitude and longitude that occur at discrete intervals within coordinate system 212 that are associated with specific geographic distances. It follows that each subpart of the polygon, as well as the portion of the one or more spatial regions that is contained within each subpart, may be located within a different one of such quadrangles. The plurality of line sets that surround each subpart may, for instance, allow for the ray casting techniques described herein to be applied at a quadrangular level. In this way, one or more components of system 100 and/or 200 may, for instance, determine whether each spatial record is included in the subpart of polygon 210 that is contained within the quadrangle that the spatial record has been identified as being located within. The plurality of subparts may, in some examples, include a plurality of cells within a bounding box for the polygon. Such cells may, for instance correspond to quadrangles that at least partially overlap with a bounding box for the polygon. In such implementations, a subpart that does not include an edge intersecting a perimeter of the subpart may, in some instances, be excluded from the generating and the adding. This may, for instance, allow one or more components of system 100 and/or 200, as described above in reference to FIGS. 1 and 2, to simply disregard any identified quadrangles within which (i) one or more portions of a bounding box or envelope around polygon 210 are located, and (ii) no portion of polygon 210 is located. In addition, a line parallel to the ray may, in some of such implementations, be excluded from and not added to the plurality of lines.

The process 300 may include accessing, by the computer system, information that identifies a spatial record positioned at a location on the coordinate system (330). In some examples, accessing, by the computer system, information that identifies a spatial record positioned at a location on the coordinate system may include the computer system using a spatial index that includes spatial data and non-spatial data. The accessing of stage 330 may correspond to one or more components of system 100 and/or 200, such as location-based search engine 140 as described above in reference to FIGS. 1 and 2, accessing information stored in search corpus database 150 and/or an index maintained in association with search corpus database 150 that identifies one or more resources/records that are associated with a position on the coordinate system 212, such as a particular one of records A through G associated with respective positions [x_{A},y_{A}] through [x_{G},y_{G}] on the coordinate system 212, respectively. The respective positions on the coordinate system 212 with which the resources/records are associated may, in some examples, correspond to a geographical location of a property for which the resources/records includes listing information.

Using a spatial index that includes both spatial data and non-spatial data improves the efficiency of the disclosed spatial search relative to conventional spatial searches. This is because the accessing of stage 330 can identify a set of resources/records A through G using both spatial and non-spatial search criteria received by the computer system at stage 310. This can result less resources/records that need to be further evaluated at stages 340 and 350. For example, data identifying a polygon and a specific real-estate listing criterion can be received at stage 310. In such instances, the computer system can, in some implementations, identify the plurality of lines that represent the polygon at stage 320 and then access one or more records that potentially fall within the polygon and are associated with the real-estate listing criteria received at stage 310 such as a price range. Accordingly, the real-estate resources/records A through G may only include resources/records A through G that potentially fall within the polygon and have three bedrooms. Therefore, stages 340 and 350 will not be performed for resources/records that potentially fall within the bounding box of the received polygon and have 1 bedroom, 2 bedrooms, 4 bedrooms, or the like. For example, the computer system may determine to exclude a real-estate resource/record D from the operations performed at stages 340 and 350, based on a search of the spatial index including both spatial data and non-spatial data, because the resource/record D is determined to be outside of the price range specified by the received real-estate criterion even though the property D may be associated with a geographical location that falls within the bounding box of the polygon

The process 300 may include generating, by the computer system, a ray that emanates from the spatial record and that is projected in a particular direction (340). The particular direction in which the ray that emanates from the spatial record, as generated by the computer system, is projected may, for instance, correspond to a substantially horizontal direction or a substantially vertical direction across the coordinate system. For example, this may correspond to one or more components of system 100 and/or 200, such as polygon data processor 143 of location-based search engine 140 as described above in reference to FIGS. 1 and 2, generating ray r_{A} that emanates from location [x_{A}, y_{A}] associated with record A and that is projected in a positive direction along the x-axis of the coordinate system 212, generating ray r_{B} that emanates from location [x_{B}, y_{B}] associated with record B and that is projected in a positive direction along the x-axis of the coordinate system 212, or generating rays from another locations described above in reference to FIG. 2.

The process 300 may include determining, by the computer system, whether the location of spatial record is included, at least partially, within the one or more spatial regions based, at least in part, on a number of times that the ray intersects the plurality of lines (350). This may, for instance, correspond to one or more components of system 100 and/or 200, such as polygon data processor 143 of location-based search engine 140 as described above in reference to FIGS. 1 and 2, determining whether location [x_{A}, y_{A}] associated with record A is located within the confines of polygon 210 based on the number of times that ray r_{A} intersects the plurality of lines 210a-210j, determining whether location [x_{B}, y_{B}] associated with record B is located within the confines of polygon 210 based on the number of times that ray r_{B} intersects the plurality of lines 210a-210j, or determining whether locations associated with any other the other locations described above in reference to FIG. 2 are located within the confines of polygon 210 based on the number of times that rays generated from such other locations intersect the plurality of lines 210a-210j that represent polygon 210. In some examples, this may instead correspond to one or more components of system 100 and/or 200, such as polygon data processor 143 of location-based search engine 140 as described above in reference to FIGS. 1 and 2, determining whether one or more of such locations associated with record A are located within the confines or polygon 210 based on the number of times that each respective ray intersects an identified plurality of lines that extend between each point within coordinate system 212 at which the outline of polygon 210 intersects with the outline of one of the one or more quadrangles having been identified for polygon 210.

In some implementations, the spatial record may be determined to be located, at least partially, inside of the polygon based on the ray intersecting the plurality of lines an odd number of times. For instance, in the example of FIG. 2, the location [x_{B}, y_{B}] associated with record B may be determined to be located within the confines of polygon 210 as a result of ray r_{B} intersecting the plurality of lines 210a-210j an odd number of times. Similarly, the spatial record may, in some implementations, be determined to be located, at least partially, outside of the polygon based on the ray intersecting the plurality of lines an even number of times. For instance, in the example of FIG. 2, the location [x_{A}, y_{A}] associated with record A may be determined to be located outside of polygon 210 based on ray r_{A} intersecting the plurality of lines 210a-210j an even number of times. In some examples, lines that are parallel to the ray are excluded from a count of the number of times that the ray intersects the plurality of lines. In the example of FIG. 2, polygon data processor 143 may simply disregard any intersections that may exist between r_{A} through r_{G} and lines 210e, 210g, and 210i of the plurality of lines 210a-210j that represent polygon 210, as lines 210e, 210g, and 210i are parallel of each of rays r_{A} through r_{C}.

The process 300 may include outputting, by the computer system, information that identifies whether the spatial record is located, at least partially, inside of the polygon based on the determination (360). For example, this may correspond to one or more components of system 100 and/or 200, such as polygon data processor 143 of location-based search engine 140 as described above in reference to FIGS. 1 and 2, outputting information that identifies whether a particular one of records A through G is located at least partially inside the confines of polygon 210 and that may be utilized by location-based search engine 140 to at least in part determine search results 220. In some examples, such one or more components of system 100 and/or 200 may simply output indication of whether a particular one of records A through G is located at least partially inside the confines of polygon 210 to other system components, such as search corpus database 150, independent of any search having been requested by a user of system 100 and/or 200.

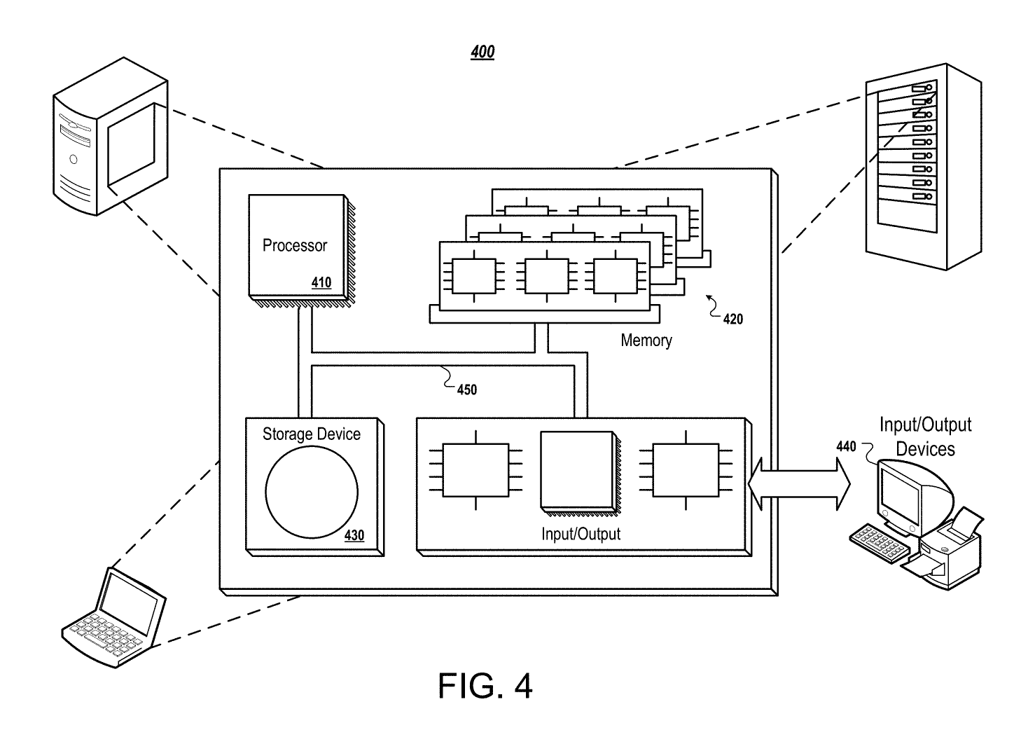

FIG. 4 is a schematic diagram of an example of a generic computer system 400. The system 400 can be used for the operations described in association with FIGS. 1-3 according to some implementations. The system 400 may include system 100, may provide graphical user interface 200, and may perform process 300.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method to determine whether a spatial record is located within a polygon, the method comprising:
receiving, at a computer system, data identifying a polygon with a plurality of edges that are connected and enclose one or more spatial regions, the polygon being positioned on a coordinate system;
identifying, by the computer system, a plurality of lines to represent the polygon based on the plurality of edges;
accessing, by the computer system, information that identifies a spatial record positioned at a location on the coordinate system using a spatial index that includes spatial data and non-spatial data;
generating, by the computer system, a ray that emanates from the spatial record and that is projected in a particular direction;
determining, by the computer system, whether the location of spatial record is included, at least partially, within the one or more spatial regions based, at least in part, on a number of times that the ray intersects the plurality of lines; and
outputting, by the computer system, information that identifies whether the spatial record is located, at least partially, inside of the polygon based on the determination.

2. The computer-implemented method of claim 1, wherein the spatial record is determined to be located, at least partially, inside of the polygon based on the ray intersecting the plurality of lines an odd number of times.

3. The computer-implemented method of claim 1, wherein the spatial record is determined to be located, at least partially, outside of the polygon based on the ray intersecting the plurality of lines an even number of times.

4. The computer-implemented method of claim 1, wherein lines that are parallel to the ray are excluded from a count of the number of times that the ray intersects the plurality of lines.

5. The computer-implemented method of claim 1, wherein the particular direction comprises a substantially horizontal direction or a substantially vertical direction across the coordinate system.

6. The computer-implemented method of claim 1, wherein identifying the plurality of lines comprises:
segmenting, by the computer system, the polygon into a plurality of subparts;
generating, by the computer system, a plurality of line sets for the plurality of subparts, each of the plurality of line sets including one or more lines that define a portion of the one or more spatial regions that is contained within a corresponding one of the plurality of subparts; and
adding, by the computer system, lines from the plurality of line sets to the plurality of lines.

7. The computer-implemented method of claim 6, wherein a subpart that does not include an edge intersecting a perimeter of the subpart is excluded from the generating and the adding.

8. The computer-implemented method of claim 6, wherein a line parallel to the ray is excluded from and not added to the plurality of lines.

9. The computer-implemented method of claim 6, wherein the plurality of subparts comprises a plurality of cells within a bounding box for the polygon.

10. The computer-implemented method of claim 1, wherein the coordinate system comprises a Cartesian coordinate system.

11. A computer program product, encoded on one or more non-transitory computer storage media, comprising instructions that when executed by one or more computers cause the one or more computers to perform operations comprising:
receiving, at the one or more computers, data identifying a polygon with a plurality of edges that are connected and enclose one or more spatial regions, the polygon being positioned on a coordinate system;
identifying, by the one or more computers, a plurality of lines to represent the polygon based on the plurality of edges;
accessing, by the one or more computers, information that identifies a spatial record positioned at a location on the coordinate system using a spatial index that includes spatial data and non-spatial data;
generating, by the one or more computers, a ray that emanates from the spatial record and that is projected in a particular direction;
determining, by the one or more computers, whether the location of spatial record is included, at least partially, within the one or more spatial regions based, at least in part, on a number of times that the ray intersects the plurality of lines; and
outputting, by the one or more computers, information that identifies whether the spatial record is located, at least partially, inside of the polygon based on the determination.

12. The computer program product of claim 11, wherein the spatial record is determined to be located, at least partially, inside of the polygon based on the ray intersecting the plurality of lines an odd number of times.

13. The computer program product of claim 11, wherein the spatial record is determined to be located, at least partially, outside of the polygon based on the ray intersecting the plurality of lines an even number of times.

14. The computer program product of claim 11, wherein lines that are parallel to the ray are excluded from a count of the number of times that the ray intersects the plurality of lines.

15. The computer program product of claim 11, wherein the particular direction comprises a substantially horizontal direction or a substantially vertical direction across the coordinate system.

16. A system comprising:
one or more computers and one or more storage devices storing instructions that are operable, when executed by the one or more computers, to cause the one or more computers to perform operations comprising:
receiving, at the one or more computers, data identifying a polygon with a plurality of edges that are connected and enclose one or more spatial regions, the polygon being positioned on a coordinate system;
identifying, by the one or more computers, a plurality of lines to represent the polygon based on the plurality of edges;
accessing, by the one or more computers, information that identifies a spatial record positioned at a location on the coordinate system using a spatial index that includes spatial data and non-spatial data;
generating, by the one or more computers, a ray that emanates from the spatial record and that is projected in a particular direction;
determining, by the one or more computers, whether the location of spatial record is included, at least partially, within the one or more spatial regions based, at least in part, on a number of times that the ray intersects the plurality of lines; and
outputting, by the one or more computers, information that identifies whether the spatial record is located, at least partially, inside of the polygon based on the determination.

17. The system of claim 16, wherein the spatial record is determined to be located, at least partially, inside of the polygon based on the ray intersecting the plurality of lines an odd number of times.

18. The system of claim 16, wherein the spatial record is determined to be located, at least partially, outside of the polygon based on the ray intersecting the plurality of lines an even number of times.

19. The system of claim 16, wherein lines that are parallel to the ray are excluded from a count of the number of times that the ray intersects the plurality of lines.

20. The system of claim 16, wherein the particular direction comprises a substantially horizontal direction or a substantially vertical direction across the coordinate system.
